(19) United States
(12) Patent Application Publication
(10) Pub. No.: US 2010/0289705 A1
(43) Pub. Date: Nov. 18, 2010

(54) Mountable Antenna Elements for Dual Band Antenna

(76) Inventors: Victor Shtrom, Los Altos, CA (US); Bernard Baron, Mountain View, CA (US)

Correspondence Address: CARR & FERRELL LLP, 2200 GENG ROAD, PALO ALTO, CA, 94303, US

(21) Appl. No.: 12/545,758

(22) Filed: Aug. 21, 2009

Related U.S. Application Data
(60) Provisional application No. 61/177,546, filed on May 12, 2009.

(51) Int. Cl. H01Q 1/24; H01Q 1/50; H01Q 15/14

(52) U.S. Cl. 343/702; 343/860; 343/912

(57) ABSTRACT

A mountable antenna element is constructed as an object from a single piece of material and can be configured to transmit and receive RF signals, achieve optimized impedance values, and operate in a concurrent dual-band system. The mountable antenna element may have one or more legs, an RF signal feed, and one or impedance matching elements. The legs and RF signal feed can be coupled to a circuit board. The impedance matching elements can be utilized to create a capacitance with a portion of the circuit board and thereby optimize impedance of the antenna element at a desired operating frequency. The mountable antenna includes features that enable it for use in concurrent dual band operation with the wireless device. Because the mountable antenna element can be installed without needing additional circuitry for matching impedance and can be constructed from a single piece of material, the antenna element provides for more efficient manufacturing.

### CROSS-REFERENCE TO RELATED APPLICATION

The present application claims the priority benefit of U.S. provisional patent application No. 61/177,546 filed May 12, 2009 and entitled “Mountable Antenna Elements for Dual Band Antenna,” the disclosure of which is incorporated herein by reference.

### BACKGROUND OF THE INVENTION

1. Field of the Invention

The present invention generally relates to wireless communications. More specifically, the present invention relates to mountable antenna elements for dual band antenna arrays.

2. Description of the Related Art

In wireless communications systems, there is an ever-increasing demand for higher data throughput and reduced interference that can disrupt data communications. A wireless link in an Institute of Electrical and Electronic Engineers (IEEE) 802.11 network may be susceptible to interference from other access points and stations, other radio transmitting devices, and changes or disturbances in the wireless link environment between an access point and remote receiving node. The interference may degrade the wireless link thereby forcing communication at a lower data rate. The interference may, in some instances, be sufficiently strong as to disrupt the wireless link altogether.

FIG. 1 is a block diagram of a wireless device 100 in communication with one or more remote devices and as is generally known in the art. While not shown, the wireless device 100 of FIG. 1 includes antenna elements and a radio frequency (RF) transmitter and/or a receiver, which may operate using the 802.11 protocol. The wireless device 100 of FIG. 1 may be encompassed in a set-top box, a laptop computer, a television, a Personal Computer Memory Card International Association (PCMCIA) card, a remote control, a mobile telephone or smart phone, a handheld gaming device, a remote terminal, or other mobile device.

In one particular example, the wireless device 100 may be a handheld device that receives input through an input mechanism configured to be used by a user. The wireless device 100 may process the input and generate a corresponding RF signal, as may be appropriate. The generated RF signal may then be transmitted to one or more receiving nodes 110-140 via wireless links. Nodes 120-140 may receive data, transmit data, or transmit and receive data (i.e., a transceiver).

Wireless device 100 may also be an access point for communicating with one or more remote receiving nodes over a wireless link as might occur in an 802.11 wireless network. The wireless device 100 may receive data as a part of a data signal from a router connected to the Internet (not shown) or a wired network. The wireless device 100 may then convert and wirelessly transmit the data to one or more remote receiving nodes (e.g., receiving nodes 110-140). The wireless device 100 may also receive a wireless transmission of data from one or more of nodes 110-140, convert the received data, and allow for transmission of that converted data over the Internet via the aforementioned router or some other wired device. The wireless device 100 may also form a part of a wireless local area network (LAN) that allows for communications among two or more of nodes 110-140.

For example, node 110 may be a mobile device with WiFi capability. Node 110 (mobile device) may communicate with node 120, which may be a laptop computer including a WiFi card or wireless chipset. Communications by and between node 110 and node 120 may be routed through the wireless device 100, which creates the wireless LAN environment through the emission of RF and 802.11 compliant signals.

Efficient manufacturing of wireless device 100 is important to provide a competitive product in the market place. Manufacture of a wireless device 100 typically includes construction of one or more circuit boards and one or more antenna elements. The antenna elements can be built into the circuit board or manually mounted to the wireless device. When mounted manually, the antenna elements are attached to the surface of the circuit board and typically soldered although those elements may be attached by other means.

When surface-mounted antenna elements are used in a wireless device, the impedance of the antenna elements should be matched to achieve optimal efficiency of the wireless device. Previous surface-mount antenna elements require circuitry components for matching the antenna element impedance. For example, wireless device circuit boards are designed to have circuitry components such as capacitors and inductors which match impedance of the surface-mounted antenna elements. Additionally, some surface mounted antenna elements require additional elements to create a capacitance that matches the impedance of the antenna element. Manufacture of wireless devices with surface-mount antenna elements and separate impendence matching components is inefficient and increases manufacturing costs for the device.

### SUMMARY OF THE PRESENTLY CLAIMED INVENTION

A first embodiment of a mountable antenna element for transmitting a radio frequency signal includes a top surface, a radio frequency feed, a plurality of legs, and an impedance matching element. The top surface is in a first plane. The radio frequency (RF) feed extends from the top surface and is coupled to an RF source. The impedance matching element extends from the top surface. The impedance matching element can achieve an impedance for the antenna element when the antenna element radiates the RF signal. The top surface, RF feed element, plurality of legs, and impedance matching element are constructed as a single object.

In a second claimed embodiment, a printed circuit board mountable reflector configured to reflect an RFID signal includes a stem, an element connected to the stem and a least one coupling plate coupled to a base of the stem. The stem is configured to extend away from the PCB and the element extends perpendicular to the stem. The at least one coupling plate is configured to be coupled to the PCB. A coupling plate is coupled to a base of the second end and configured to be coupled to the mounting surface.

In a second claimed embodiment, a wireless device for transmitting a radiation signal can include a circuit board, a mountable antenna element and a radio modulator/demodulator. The circuit board is configured to receive a first mountable antenna element for radiating at a first frequency.

The mountable antenna is coupled to the circuit board and includes an RF feed, a top surface, a plurality of legs, and an impedance matching element. The plurality of legs may couple the first mountable antenna element to the PCB. The impedance matching element configured to form a capacitance with respect to a ground layer in the PCB. The radio modulator/demodulator is configured to provide an RF signal to the mountable antenna element at the first frequency.

### BRIEF DESCRIPTION OF THE FIGURES

FIG. 1 is a block diagram of a wireless device in communication with one or more remote devices.

FIG. 2 a block diagram of a wireless device.

FIG. 3 illustrates a portion of a circuit board for receiving mountable antenna elements and reflectors, like those referenced in FIG. 2.

FIG. 4 is a perspective view of a mountable antenna element.

FIG. 5 is a top view of the mountable antenna element of FIG. 4.

FIG. 6A is a side view of the mountable antenna element of FIG. 4.

FIG. 6B is a top view of a single object or piece of material for forming an exemplary mountable antenna element.

FIG. 7A is perspective view of a mountable reflector.

FIG. 7B is side view of the mountable reflector of FIG. 7A.

FIG. 8 is a top view of a mountable antenna element and an array of mountable reflectors.

FIG. 9 is a perspective view of an alternative embodiment of a mountable antenna element.

FIG. 10 is a top view of an alternative embodiment of a mountable antenna element.

FIG. 11 is a side view of an alternative embodiment of a mountable antenna element.

FIG. 12 is perspective view of an alternative embodiment of a mountable reflector.

FIG. 13 is a top view of an alternative embodiment of a mountable antenna element and an array of mountable reflectors.

FIG. 14 is a graph illustrating a relationship between impedance matching element distance and impedance.

### DETAILED DESCRIPTION

A mountable antenna element constructed as a single element or object from a single piece of material can be configured to transmit and receive RF signals, achieve optimized impedance values, and operate in a concurrent dual-band system. The mountable antenna element may have one or more legs, an RF signal feed, and one or more impedance matching elements. The legs and RF signal feed can be coupled to a circuit board. The impedance matching elements can be utilized to create a capacitance with a portion of the circuit board thereby optimizing impedance of the antenna element at a desired operating frequency. The mountable antenna can also include one or more stubs that enable it for use in concurrent dual band operation with the wireless device. Because the mountable antenna element can be installed without the need for additional circuitry to match impedance and can be constructed as a single object or as a single piece of material, the mountable antenna element allows for more efficient manufacturing.

The one or more impedance matching elements of the mountable antenna element are configured to achieve optimized impedance for the mountable antenna element. The impedance matching elements are part of the single object comprising the antenna element, and positioned downward away from a top surface of the mountable antenna and towards a circuit board ground plane. The one or more impedance matching elements may each achieve a capacitance with respect to the ground plane, wherein the capacitance achieves the impedance matching for the antenna element. The impedance matching for the mountable antenna allows for a cleaner and more efficient signal to be broadcast (and received) at a desired frequency for the antenna element.

The legs of the antenna element may each contain one or more stubs in a close proximity of the leg. The stubs are configured to create an open circuit in the leg for a particular frequency. The open circuit prevents current from being induced up the leg and into the mountable antenna element thereby affecting radiation of a smaller sized antenna due to a larger antenna element associated with the leg. The larger mountable antenna element is “transparent,” or does not interfere with a smaller mountable antenna element, as a result of preventing an induced current in the larger antenna element due to radiation from the smaller antenna element.

A reflector may also be mounted to a circuit board having a mountable antenna element. The reflector can reflect radiation emitted by the antenna element. The reflector can be constructed as an element or object from a single piece of material and mounted to the circuit board in a position appropriate for reflecting radiation emitted from the antenna element. The reflector can include one or more pins and a plate for installing the reflector to the circuit board. When reflector pins are inserted into designated holes in the circuit board and the reflector plate is in contact with a circuit board pad, the reflector may stand on its own. As a result, the process of securing the reflector to the circuit board is made easier.

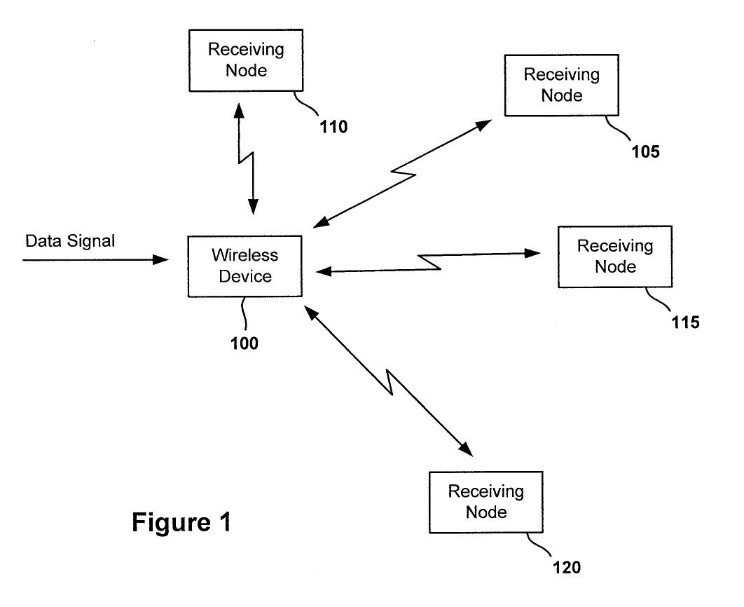

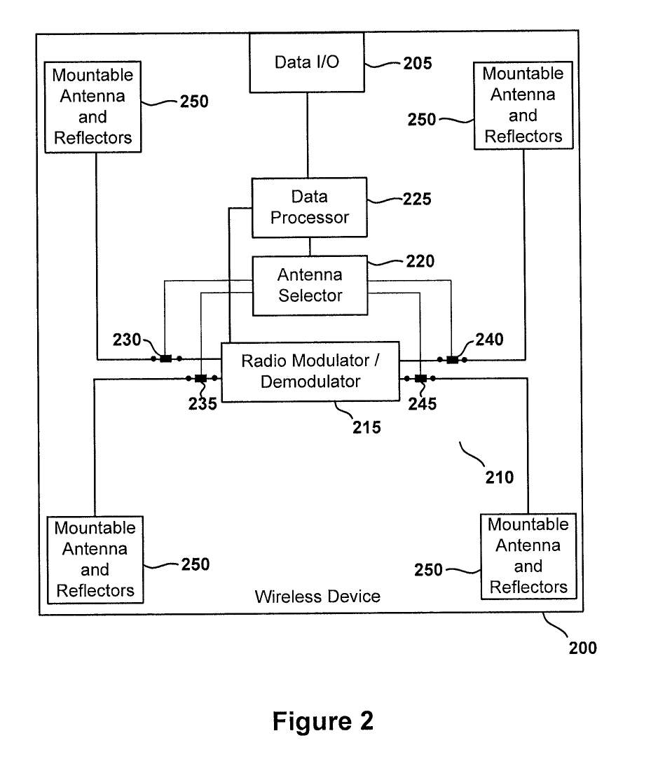

FIG. 2 is a block diagram of a wireless device 200. The wireless device 200 of FIG. 2 may be used in a fashion similar to that of wireless device 110 as shown in and described with respect to FIG. 1. The components of wireless device 200 can be implemented on one or more circuit boards. The wireless device 200 of FIG. 2 includes a data input/output (I/O) module 205, radio modulator/demodulator 215, an antenna selector 220, a data processor 225, and diode switches 230, 235, 240, and 245. Block diagram 200 also illustrates mountable antenna and reflector sets 250.

The data I/O module 205 of FIG. 2 receives a data signal from an external source such as a router. The data I/O module 205 provides the signal to wireless device circuitry for wireless transmission to a remote device (e.g., nodes 110-140 of FIG. 1). For example, the wired data signal can be processed by data processor 225 and radio modulator/demodulator 215. The processed and modulated signal may then be transmitted via one more antenna elements within the mountable antenna and reflectors 250 as described in further detail below.

The antenna selector 220 of FIG. 2 can select one or more antenna elements within mountable antenna and reflectors 250 to radiate the processed and modulated signal. Antenna selector 220 is connected to and may control one or more of diode switches 230, 235, 240, or 245 to direct the processed data signal to the one or more antenna sets 250. Antennal selector 220 may also select one or more reflectors for reflecting the signal in a desired direction. Processing of a data signal and feeding the processed signal to one or more selected antenna elements is described in detail in U.S. Pat. No. 7,193,562, entitled, “Circuit Board Having a Peripheral Antenna Apparatus with Selectable Antenna Elements,” the disclosure of which is incorporated by reference.

The mountable antenna and reflectors 250 include at least one antenna element and at least one reflector and can be located at various locales on the circuit board of a wireless device, including at the periphery of the circuit board. A mountable antenna element may also be used in a wireless device without a reflector. Each set of mountable antenna and reflectors 250 may include an antenna element configured to operate at one or more frequencies. Each mountable antenna may be configured to radiate at a particular frequency, such as 2.4 GHz or 5.0 GHz. To minimize any potential interference between antennas radiating at different frequencies within a wireless device, mountable antennas radiating at different frequencies can be placed as far apart as possible on a circuit board, for example at opposite corners of a circuit board surface as is illustrated in FIG. 2.

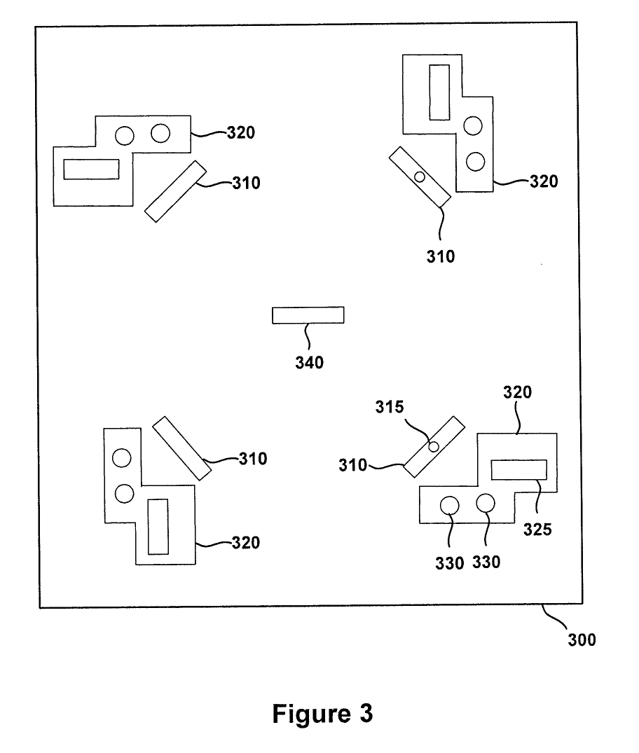

FIG. 3 illustrates a portion of a circuit board 300 for receiving a mountable antenna element and reflectors. The circuit board 300 of FIG. 3 is associated with a circuit board footprint corresponding to mountable antenna and reflectors 250 of FIG. 2. Thus, the circuit board portion illustrated in FIG. 3 provides more detail for each of the four mountable antenna and reflectors 250 of FIG. 2. The circuit board 300 includes coupling pads and holes for the coupling of an antenna element and reflectors to the board. Portions of the footprint (e.g., those related to attaching capacitors, resistors, and other elements) are not illustrated for simplicity.

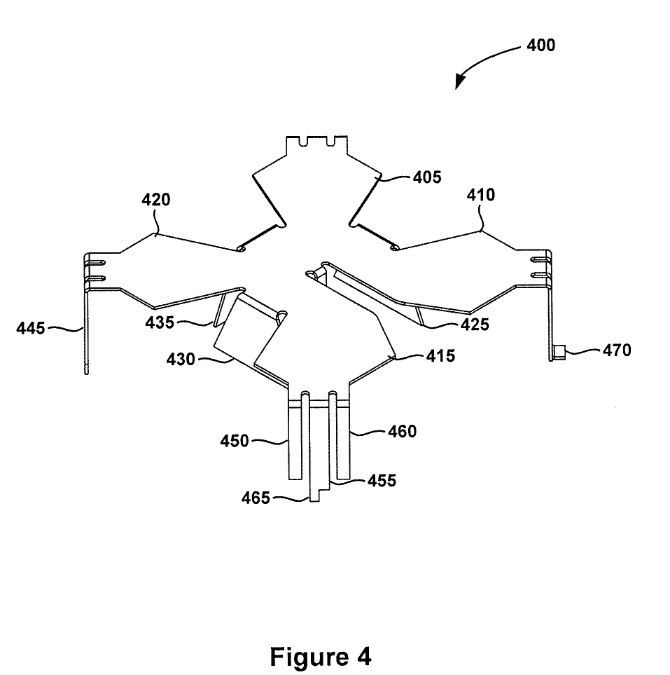

An antenna element can be coupled to the circuit board 300 at coupling pads 310 and 340. A coupling pad is a pad connected to circuit board circuitry (for example a switch 230 or ground) and to which the antenna element can be connected, for example via solder. The antenna element can include a coupling plate having a surface that, when mounted to the circuit board, is roughly parallel and in contact with the circuit board coupling pads 310 and 340. A coupling plate is an antenna element surface (e.g., a surface at the end of an antenna element leg) that may be used to connect the antenna element to a couple pad. Antenna elements having a coupling plate (e.g., coupling plate 470) are illustrated in FIGS. 4-6B and 9-11. The antenna element coupling plate can be coupled (e.g., by solder) to the couple pads 310 and 340 such that the antenna element is mechanically and electronically coupled to a particular coupling pad 310. Coupling pads 310 can be connected to ground and coupling pad 340 can be connected to a radio modulator/demodulator 215 through a diode switch (e.g., diode switch 230).

A circuit board mounting pad 310 can include one or more coupling pad holes 315. A coupling pad hole 315 is an aperture or opening that extends from the surface into one or more layers of the circuit board. The coupling pad holes can receive an antenna element pin to help the secure antenna element to the circuit board 300. The antenna element can be positioned in place on the circuit board 300 by inserting one or more pins of the antenna element into a circuit board coupling pad hole 315. Once one or more antenna element pins are inserted into the appropriate coupling pad holes, the antenna element can be secured to the circuit board by means of soldering or some other coupling operation. An antenna element with one or more pins and a coupling plate is discussed in more detail with respect to FIGS. 4-6B.

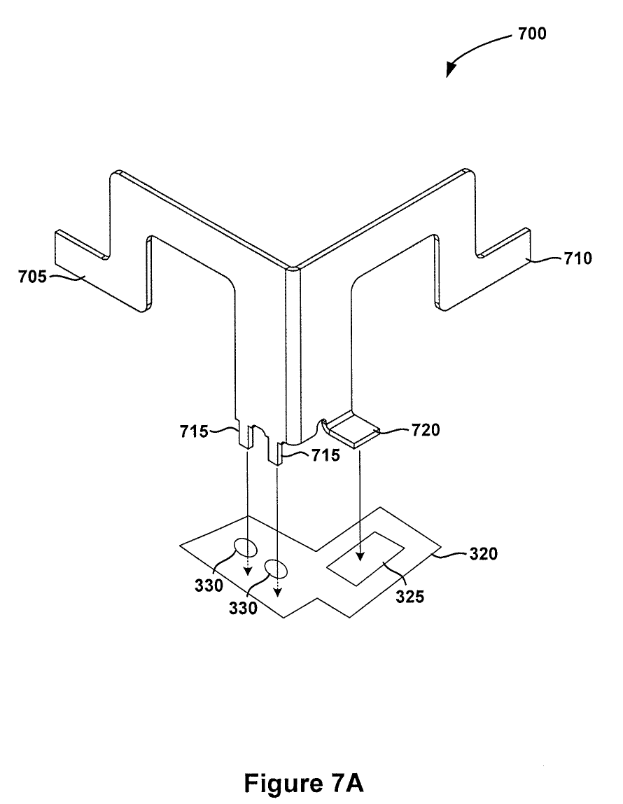

A reflector can be mounted to the circuit board 300 at coupling area 320. Coupling area 320, as illustrated in FIG. 3, can include a mounting pad 325 and one or more holes 330. A mounting pad is a pad connected to circuit board circuitry (for example a switch 230 or ground) and to which a reflector can be connected, for example via solder. The mounting pad 325 can be coupled to a mounting plate of a reflector (for example, mounting plate 720 in the reflector illustrated in FIG. 7A) such that the reflector is electronically and mechanically attached to the mounting pad 325. The mounting pad 325 may be connected to ground layer of the circuit board through a switch, such as one of switches 220-235 as illustrated in FIG. 2. When a switch connected to the reflector is open, the reflector does not change the radiation pattern of a mounted antenna element. When the switch is closed such that the reflector is connected to the ground layer, the reflector operates to reflect the radiation pattern directed at the particular reflector.

The holes 330 of coupling area 320 are formed by an aperture or opening that extends from the surface into one or more layers of the circuit board and can be used to position a reflector in an appropriate position over coupling area 320. When a reflector has one or more pins inserted into corresponding holes 330 and a mounting plate (e.g., mounting plate 720 of FIG. 7A) in contact with coupling pad 325, the reflector can stand in an upright position over coupling area 320 without further support. Once a reflector is positioned upright on coupling area 320 using holes 330 and the reflector pins, the reflector can be coupled to a mounting pad 325 by soldering or some other coupling operation.

A reflector that can maintain an upright position without external support, for example by a machine or person, allows for easy attachment of the reflector to the circuit board 300. A reflector with one or more pins and a coupling plate is discussed in more detail with respect to FIGS. 7A-9.

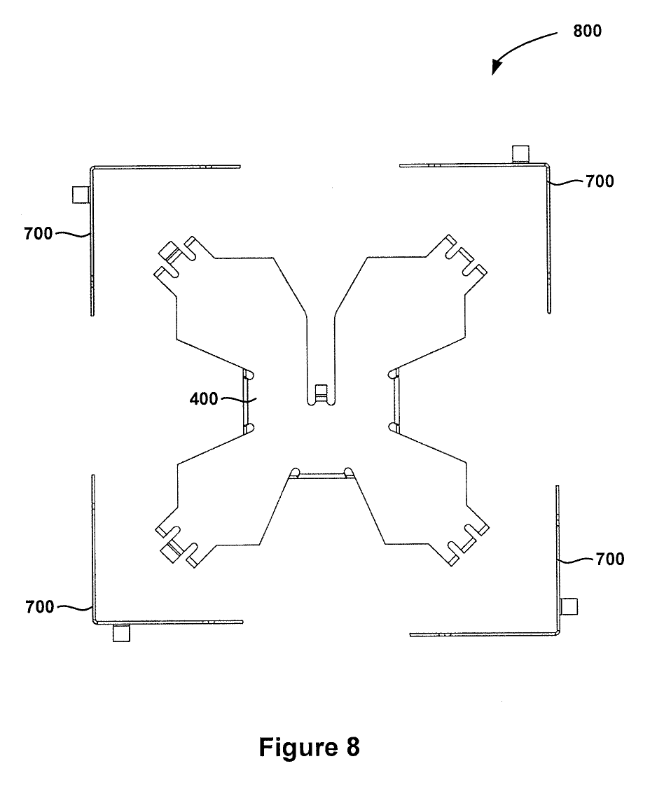

An antenna element and reflector can be designed in combination to operate at a desired frequency, such as 2.4 gigahertz (GHz) or 5.0 GHz. FIGS. 4-8 illustrate exemplary antenna element and reflector combinations for a first frequency. FIGS. 9-13 illustrate exemplary antenna element and reflector combinations for a second frequency. The antenna elements and reflectors described below can be modified to operate at other desired frequencies.

FIG. 4 is a perspective view of a mountable antenna element 400. The mountable antenna element 400 of FIG. 4 can be configured to radiate at a frequency such as 2.4 GHz. Extending horizontally outward from the center of a top surface of the antenna element 400 are top surface portions 405, 410, 415 and 420. Extending downward from each top surface portion is a leg (e.g., 455), and a stub on each side of each leg (e.g., stubs 450 and 460). As illustrated in FIG. 4, each set of a leg and two stubs extends downward at about a ninety degree angle from the plane formed by the top portions 405-420.

The antenna element legs can be used to couple the antenna element to circuit board 300 (FIG. 3). An antenna element leg can include a coupling plate 470 or a leg pin 465. A coupling plate 470 can be attached through solder to a coupling pad 310 on circuit board 300. An antenna element leg can also be attached to circuit board 300 by a leg pin 465. Leg pin 465 may be inserted into a coupling pad hole 315 in circuit board 300. An antenna element can be positioned on a circuit board by inserting the leg pins in a matching set of coupling pad holes 315 and then soldering each leg (both coupling plate and pins) to their respective coupling pads 310.

When the antenna element coupling plate 470 is connected to circuit board coupling pad 340 and a switch connecting the coupling pad 340 to radio modulator/demodulator 215 is open, no radiation pattern is transmitted or received by the mounted antenna element. When the switch is closed, the mounted antenna element is connected to radio modulator/demodulator 205 and may transmit and receive RF signals.

The antenna element stubs 450 and 460 may increase the performance of the wireless device 100 when utilizing different antenna elements to operate at multiple frequencies simultaneously, which may be referred to as concurrent dual band operation. The mountable antenna elements that operate at a smaller frequency may be larger in size than the mountable antenna elements that operate at a larger frequency. The larger mountable antenna elements, in such an instance, can interfere with the operation of the smaller antenna elements. For example, when a smaller sized antenna element (e.g., the antenna element of FIGS. 9-11) is operating at 5.0 GHz, the radiation received at antenna element 400 may cause a current to travel up a leg 455 of the larger sized antenna element 400 and towards the top portion 415. The current induced in a leg of the antenna element 400 by radiation from the smaller sized and higher frequency antenna element can affect the radiation pattern of the smaller sized antenna element and adversely affect the efficiency of wireless device 100.

To prevent the induced current, stubs 450 and 460 may create an open circuit when a radiation signal is received at the operating frequency of the smaller sized antenna element. Hence, when antenna element 400 is configured as a 2.4 GHz antenna element and operating on the same circuit board as a 5.0 GHz antenna element, stubs 450 and 460 are excited by the received 5.0 GHz radiation signal and form an open circuit at the base (the end of the leg that connects to the circuit board 300) of leg 455. The open circuit is created at the base of leg 455 at 5.0 GHz. By forming an open circuit for a 5.0 GHz signal at the base of leg 455, no current is induced through leg 455 by radiation of the higher frequency antenna element, and the larger sized antenna element 400 operating at a lower frequency does not affect the radiation of the smaller antenna element operating at a higher frequency.

The length of the stubs 450 and 460 can be chosen at time of manufacture based on the frequency of the antenna element from which radiation is being received. The total length for current traveling from the tip of one stub to the tip of the other stub can be about one half the wavelength of the frequency at which the open circuit is to be created (e.g., about three centimeters total travel length to create an open circuit for a 5.0 GHz signal). For an antenna leg with two stubs, each stub can be a little less than half of the corresponding wavelength (providing for most of the length in the stubs and a small part of the length for traveling between the stubs along a top surface portion).

Extending downward from near the center of the top surface 405, 410, 415, 420 are impedance matching elements 425, 430 and 435. Impedance matching elements 425, 430, 435 as illustrated in FIG. 4 extend downward from the top surface, such as impedance matching element 430 extending downward between top surface portions 415 and 420 and impedance matching element 435 extending downward between top surface portions 420 and 405.

Impedance matching elements 425-435 extend downward towards a ground plane within circuit board 300 and form a capacitance between the impedance matching element and the ground plane. By forming a capacitance with the ground plane of the circuit board 300, the impedance matching elements achieve impedance matching at a desired frequency of the antenna element. To achieve impedance matching, the length of the impedance matching element and the distance between the circuit board ground plane and the closest edge of the downward positioned impedance matching element can be selected based on the operating frequency of the antenna element. For example, when an antenna element 400 is configured to radiate at about 2.4 GHz, each impedance matching element may be about 8 millimeters long and positioned such that the edge closest to the circuit board is about 2-6 millimeters (e.g., about 3.6 millimeters) from a ground plane within the circuit board.

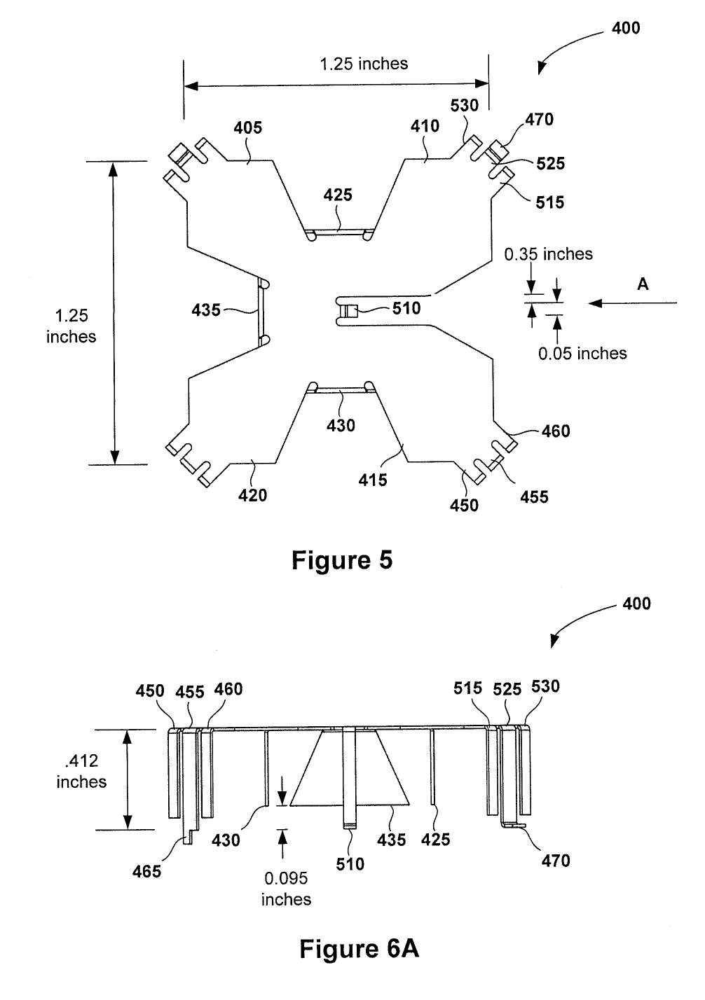

FIG. 5 is a top view of the mountable antenna element 400 of FIG. 4. The top view of antenna element 400 illustrates an radio frequency (RF) feed element 510 that can be coupled to coupling pad 340 on circuit board 300. The RF feed element 510 includes a plate that can be coupled via solder or some other process for creating a connection between the coupling pad 340 and antenna element 400 through which an RF signal can travel.

The mountable antenna element 400 of FIG. 5 is configured to radiate at 2.4 GHz. The configuration illustrated in FIG. 5 includes a width and length of about 1.25 inches. The width of the RS feed 510 is about 0.05 inches. The spacing between the RS feed and top surface portion 410 is about 0.35 inches. This particular configuration is exemplary. Other configurations and radiation frequencies may be implemented in the context of the present invention.

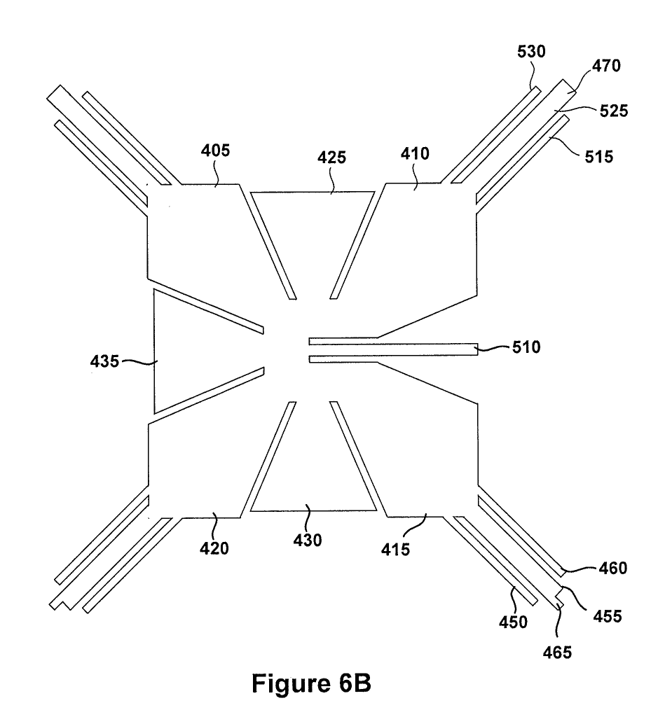

FIG. 6A is a side view of the mountable antenna element 400 of FIG. 4. The side view is from the line of perspective “A” as indicated in FIG. 5. FIG. 6A illustrates leg 455 with corresponding stubs 450 and 460 and leg 525 with corresponding stubs 515 and 530. The outer end of leg 455 includes a leg pin 465 and the outer end of leg 470 includes a mounting plate 470. The distance between the bottom surface of the plate on RF feed element 510 and the top surface of the antennae element is about is about 0.412 inches. The distance between the top surface of the antenna element and each of plate 470 on leg 615 and the bottom of leg 455 (e.g., the top of pin 465) is also about 0.412 inches. The impedance matching elements 425, 430 and 435 are collectively about the same length from the top surface of the mountable antenna element 400, and can have a length of about 0.317 inches.

FIG. 6B is a top view of a single object or piece of material for forming an exemplary mountable antenna element 400. As illustrated in FIG. 6B, the single piece of material is flat; no portions, legs, impedance matching elements or plates having been subjected to shaping by bending or manipulation. The mountable antenna element of FIGS. 4-6A can be formed by constructing the single element illustrated in FIG. 6B as one piece of material, such as tin material, and manipulating portions of the material. In particular, impedance matching elements 425, 430 and 435 can be bent downward to a position perpendicular to portions 405, 410, 415, and 420, and legs such as 470 and 455 and stubs such as 515, 530, 450 and 460 can be bent downward along the same direction as the impedance matching elements. RF feed element 510 can also be bent downward, and the edge of RF feed element 510 and leg 470 can be bent to form a plate to be coupled to circuit board 300. By constructing the antenna element 400 from a single piece of material that can be bent to operate at a tuned frequency such as 2.4 GHz while not interfering with an antenna element operating at a higher frequency (per the tuning of the stubs for each leg), the antenna element 400 can be built and installed easier than antenna elements that require additional components to generate a matching impedance.

FIG. 7A is a perspective view of a mountable reflector 700. Reflector 700 includes a first side 705 and a second side 710 disposed at an angle of about ninety degrees from one another. The two sides 705 and 710 meet at a base end and extend separately to a respective outer end. The base end of side 705 includes two mounting pins 715. As illustrated in FIG. 7A and discussed above with respect FIG. 3, the mounting pins may be used to position reflector 700 in holes 330 of a mounting area 320 of circuit board 300. The base end of side 710 includes a coupling plate 720 for coupling the reflector to a mounting pad 325 of mounting area 320 (e.g., by solder). The pins 715 can also be coupled to mounting area 320 via solder. Once the pins 715 are inserted into holes 330 and coupling plate 720 is in contact with a mounting pad 325 as illustrated in FIG. 7A, the reflector 700 can stand upright over mounting area 320 without additional support.

Reflector 700 can be constructed as an object formed from a single piece of material, such as tin, similar to the construction of antenna element 400. The reflector 700 can be symmetrical except for the pins 715 and the plate 720. Hence, the material for reflector 700 can be built as a flat and approximately “T” shaped unit with a center portion with arms extending out to either side of the center portion. The flat element can then be bent, for example, down the center of the base such that each arm is of approximately equal size and extends from the other arm at a ninety-degree angle.

FIG. 7B is a side view of the mountable reflector 700 of FIG. 7A. To reflect a frequency of about 2.4 GHz, a side (e.g., side 705) can have a length of 0.650 inches. The side 705 can extend in a non-linear shape as illustrated. The non-linear shape may have different portions in different directions and widths, for example a first top portion having a width of 0.100, a second connecting portion having width of 0.100, and an outmost end portion having a width of 0.075. The reflector can have a height of 0.425 inches from the top reflector top to the coupling plate. The reflector pins can have a width of 0.025 inches.

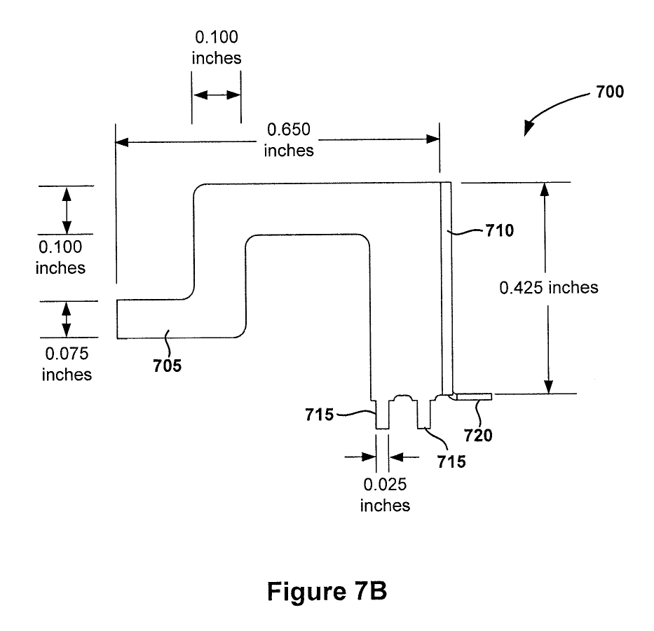

FIG. 8 is a top view of a mountable antenna element 400 and an array of mountable reflectors 700. When mounted to mounting pads 310 and 340 and mounting areas 320, the mountable antenna element 400 and reflectors 700 can be configured approximately as shown in FIG. 8. A reflector 700 can be positioned at each corner of the mountable antenna element 400. The combination of mountable antenna element 400 and reflectors 700 can be positioned at one or more of the positions 250 in the wireless device block diagram of FIG. 2. When omni-directional vertically polarized antenna element 400 radiates, one or more reflectors 700 can be shorted to ground to reflect radiation in a direction opposite of the direction from the antenna to the shorted reflectors. The result of the reflected radiation is that the transmitted signal can be directed in a particular direction.

FIG. 9 is a perspective view of an alternative embodiment of a mountable antenna element. The alternative embodiment of mountable antenna element 900 can be configured to radiate with vertical polarization at a frequency of about 5.0 GHz. Extending horizontally outward from the center of a top surface of the antenna element 900 are top surface portions 905, 910, 915, and 920. Extending downward from each top surface portion is a legs 935, 940, and 945, such as leg 940 extending from top portion 915. A fourth leg positioned opposite to leg 940 and extending from top portion 905 is not visible in FIG. 9. Each leg can extend downward at about a ninety degree angle from the plane formed by the top surface portions 905-920.

The antenna element legs can be used to couple the antenna element to circuit board 300 (FIG. 3). An antenna element leg can include a coupling plate 950 or a leg pin (not illustrated in FIG. 9). The coupling plate can be attached, for example through solder, to a coupling pad 310 on circuit board 300. An antenna element leg can also be attached to circuit board 300 by a leg pin extending from the leg. The antenna element 900 can be coupled to a circuit board by inserting the leg pins in corresponding coupling pad holes 315 and soldering each leg (both coupling plate and pins) to their respective coupling pads 310.

Extending downward from near the center of the top surface are impedance matching elements 925 and 930. A third impedance matching element is positioned opposite to impedance matching element 930 but not visible in the view of FIG. 9. The impedance matching elements 925 and 930 can extend between an inner portion of each top portion, such as impedance matching element 930 extending downward between top portions 915 and 920 and impedance matching element 925 extending downward between top portions 910 and 915.

Impedance matching elements 925-930 extend downward from the top surface toward a ground plane within circuit board 300 and form a capacitance between the impedance matching element and the ground plane. The impedance matching elements achieve impedance matching at a desired frequency based on the length of the impedance matching element and the distance between the circuit board 300 ground plane and the closest edge of the downward positioned impedance matching element based. For example, when an antenna element 900 is configured to radiate at about 5.0 GHz, each impedance matching element may be about 5 millimeters long and positioned such that the edge closest to the circuit board is between 2-6 millimeters (e.g., about 2.8 millimeters) from a ground plane within the circuit board.

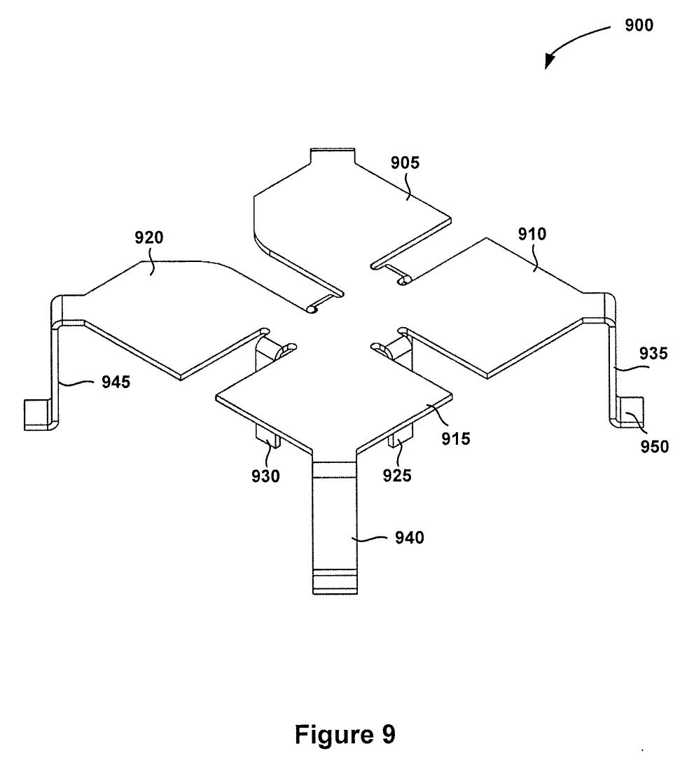

FIG. 10 is a top view of an alternative embodiment of a mountable antenna element 900. The top view of antenna element 400 indicates an RF feed element 1005 that can be coupled to coupling pad 340 on circuit board 300. The RF feed element 1005 can include a coupling plate 1007 to be coupled to coupling pad 340 via solder or some other process for creating a connection between the RF source and antenna element 400.

The dimensions of the mountable antenna element 900 can be smaller than those for mountable antenna element 400. When the mountable antenna element 900 is constructed to operate at about 5.0 GHz, the width and length of the mountable antenna element top surface can be about 0.700 inches long. The width of the gap between top surface portions 905 and 920 is 0.106 inches at the inner most point and 0.290 at the outermost point. The width of the gap between top surface portions 915 and 920 is about 0.070 inches, with the gap width between a impedance matching element and a top surface portion (e.g., impedance matching element 930 and top surface portion 915) is about 0.020 inches.

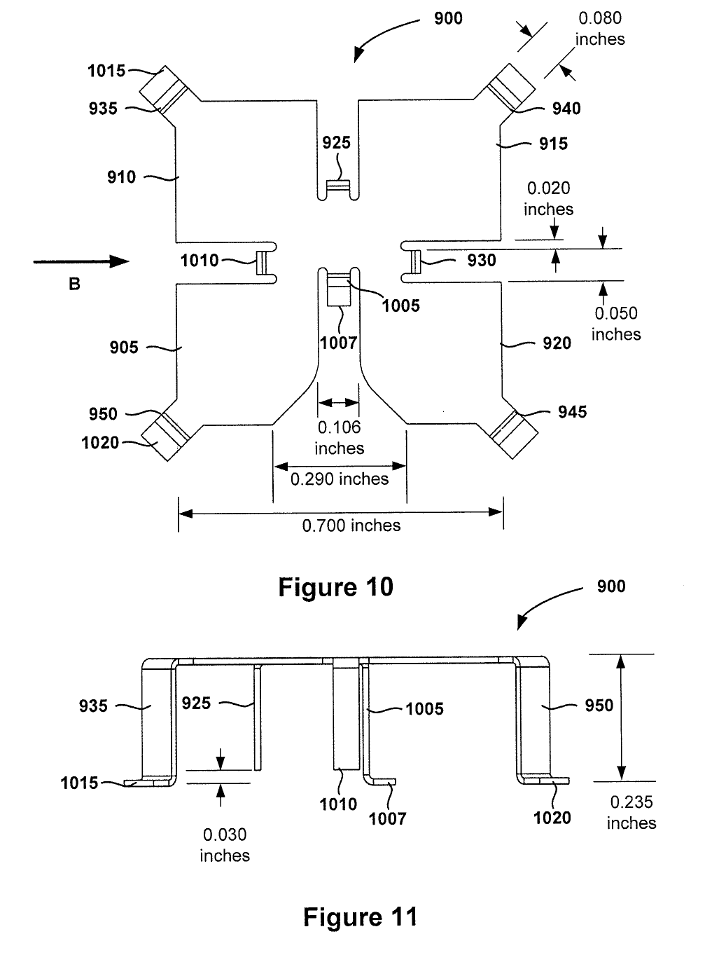

FIG. 11 is a side view of an alternative embodiment of a mountable antenna element 900. The side view is from the perspective of line “B” as indicated in FIG. 10. FIG. 11 illustrates the antenna element with leg 935 having a coupling pad 1015 and leg 950 having a coupling pad 1020, wherein both coupling pads extending horizontally there from their corresponding leg. The bottom surface of the coupling plate 1007 on RF feed element 1005 is positioned about 0.235 inches from the antenna element top surface. Coupling plates 1015 and leg 1020 are also positioned about 0.235 inches from the antenna element top surface. Antenna element 900 can be connected to an RF signal (e.g., through pad 340) through RF feed element 1005. When an RF signal is provided to RF feed element 1005, a current is created that flows from RF feed element 1005 through each of top surface portions 905, 910, 915 and 920. The current enables the antenna element to radiate with a vertical polarization. The antenna element dimensions can be selected based on the operating frequency of the element. When operating at about 5.0 GHz, the antenna element can be about 0.235 inches high. The impedance matching elements 925, 1010 and 930 (not shown in FIG. 11) are collectively about the same length from the top surface of the mountable antenna element 900 and have a length of about 0.205 inches.

Antenna element 900 can be constructed as an object from a single piece of material, for example tin material. The mountable antenna element 900 can be formed from the single piece of material by manipulating portions of the material. In particular, antenna element impedance matching elements 925, 930 and 1010 can be bent downward, for example to a position perpendicular to top surface portions 905, 910, 915 and 920, and legs 935, 940, 945, and 950 can be bent downward along the same direction as the impedance matching elements. RF feed element 1005 can also be positioned in a downward direction with respect to the antenna element top surface, and the edge of RF feed element 1005 and leg 470 can be bent to form a coupling plate to be coupled to circuit board 300.

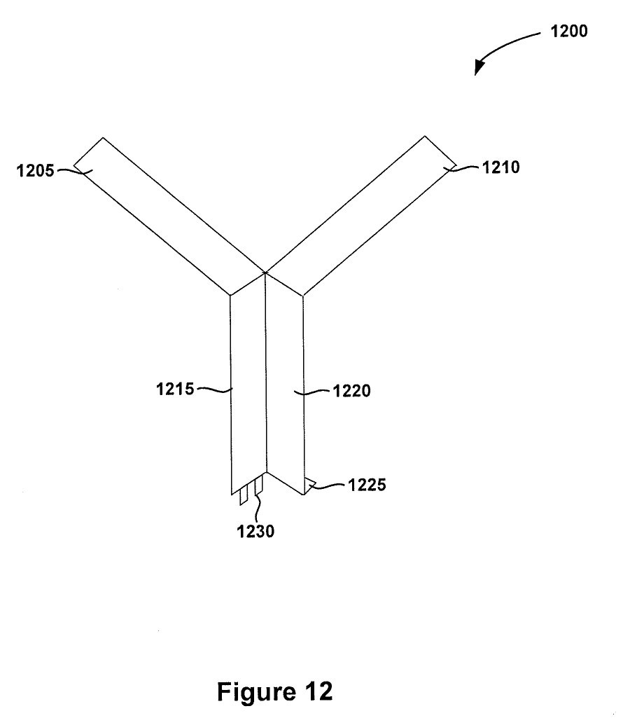

FIG. 12 is a perspective view of an alternative embodiment of a mountable reflector 1200. The mountable reflector 1200 can be used to reflect a signal having a frequency of 5.0 GHz when connected to ground, for example a signal radiated by antenna element 900. Reflector 1200 includes two sides 1215 and 1220 which form a base portion and side extensions 1205 and 1210, respectively. The side extensions are configured to extend about ninety degrees from each other. Base 1215 includes two mounting pins 1230. As illustrated in FIG. 7A and discussed above, the mounting pins may be used to position reflector 1200, for example via solder, in holes 330 of a mounting area 320 of a circuit board 300.

Base 1220 includes a mounting plate 1225. Mounting plate 1225 can be used to couple reflector 1200 to circuit board 300 via solder. In addition to mounting plate 1225, pins 1215 can also be soldered to area 320. Once the pins 1230 are inserted into holes 330 and coupling plate 1225 is in contact with a mounting pad, the reflector 1200 can stand upright without additional support, making installation of the reflectors easer than typical reflectors which do not have mounting pins 1230 and a mounting plate 1225.

Reflector 1200 can be constructed as an object from a single piece of material, such as a piece of tin. The reflector 1200 can be symmetrical except for the pins 1230 and the plate 1225. Hence, the material for reflector 1200 can be built as a flat and approximately “T” shaped unit. The flat element can then be bent down the center such that each arm is of approximately equal size and extends from the other arm at a ninety-degree angle.

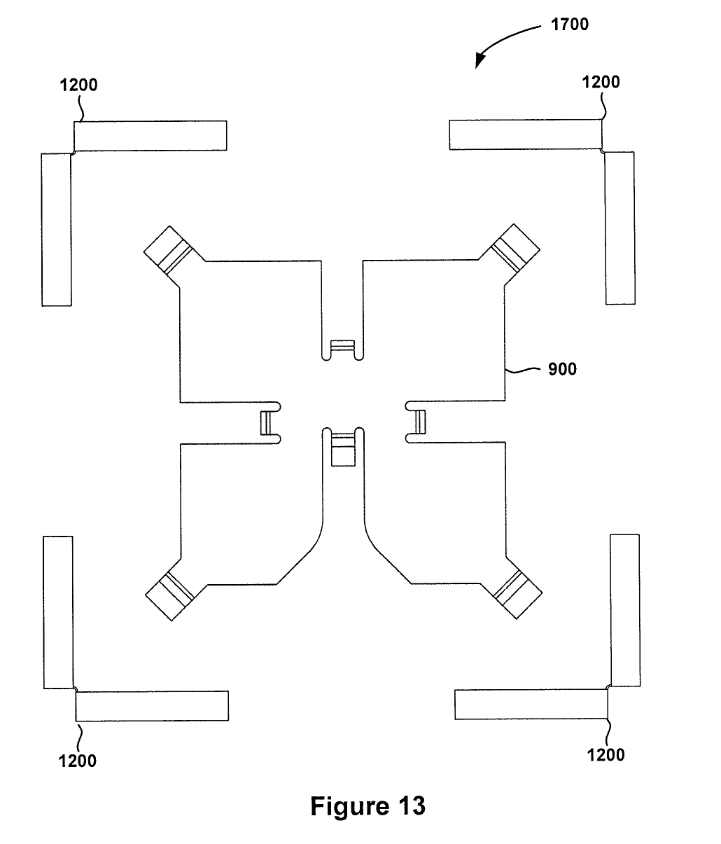

FIG. 13 is a top view of an alternative embodiment of a mountable antenna element 400 and an array of mountable reflectors 700. When mounted to mounting pads 310 and 340 and mounting areas 320, the mountable antenna element and reflectors can be configured approximately as shown in FIG. 13 such that the reflectors are positioned at each corner of the mountable antenna element 400. The combination of mountable antenna element 400 and reflectors 700 can be positioned at one or more of the positions 250 in the wireless device block diagram of FIG. 2. When omni-directional vertically polarized antenna element 400 radiates, one or more reflectors 700 can be shorted to ground to reflect radiation in a direction opposite of the direction from the antenna to the reflectors that are shorted.

Though a finite number of mountable antenna elements are described herein, other variations of single piece construction mountable antenna elements are considered within the scope of the present technology. For example, an antenna element 400 generally has an outline of a generally square shape with extruding legs and stubs as illustrated in FIG. 6B. Other shapes can be used to form a single piece antenna element, including a triangle and a circle, with one or more legs and impedance matching elements, and optionally one or more stubs to enable efficient operation with other antenna elements. Additionally, other shapes and configuration may be used to implement one or more reflectors with each antenna element.

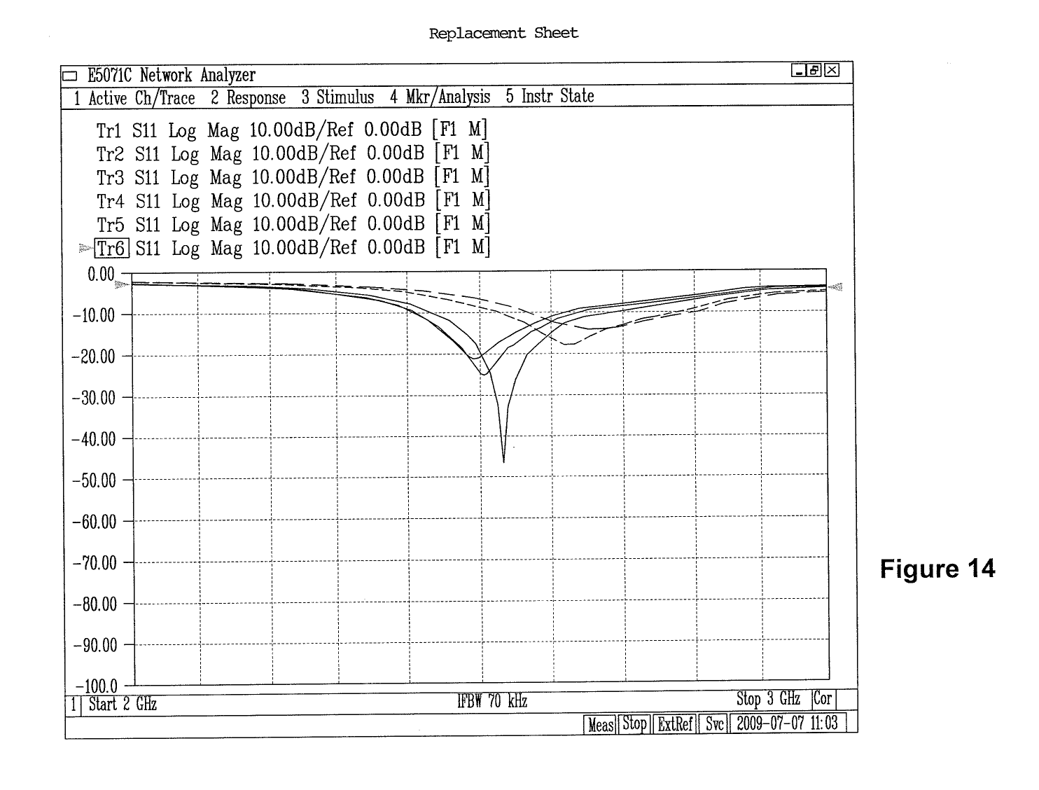

FIG. 14 is a graph illustrating a relationship between impedance matching element distance and impedance. The distance values correspond to the distance between an impedance matching element and a ground plane in a PCB. The corresponding impedance values show how the impedance (S11) can be influenced by adjusting the distance of the impedance matching element to ground. The set of curves in the figure was produced by varying the distance to ground between 60-90 millimeters. In some wireless devices, the impedance matching element to ground distance can be about 75 millimeters.

The embodiments disclosed herein are illustrative. Various modifications or adaptations of the structures and methods described herein may become apparent to those skilled in the art. Such modifications, adaptations, and/or variations that rely upon the teachings of the present disclosure and through which these teachings have advanced the art are considered to be within the spirit and scope of the present invention. Hence, the descriptions and drawings herein should be limited by reference to the specific limitations set forth in the claims appended hereto.

What is claimed is:

1. A self-standing mountable antenna for transmitting a radio frequency signal, the antenna comprising:
a top surface in a first plane;
a radio frequency (RF) feed extending from the top surface and coupled to an RF source;
a plurality of legs extending from the top surface and coupled to ground; and
a first impedance matching element extending from the top surface, wherein the top surface, the RF feed, the plurality of legs and the first impedance matching element are constructed of a single object.

2. The self-standing mountable antenna of claim 1, the first impedance matching element extending away from the top surface towards ground.

3. The self-standing mountable antenna of claim 1, further including a second impedance matching element positioned symmetrically across from the first impedance matching element in the self-standing mountable antenna.

4. The self-standing mountable antenna of claim 1, the first impedance matching configured to form a capacitance with a ground plane of a circuit board.

5. The self-standing mountable antenna of claim 1, the mountable antenna configured to be driven at a first frequency, the first impedance matching configured to provide impedance matching at the first frequency.

6. The self-standing mountable antenna of claim 1, further including a stub extending from the top surface and positioned approximate to a leg of the plurality of legs, the stub configured to form an open circuit with the leg when the leg is exposed to a broadcast signal at a second frequency.

7. The self-standing mountable antenna of claim 6, wherein the length of the stub is about one-quarter of the wavelength of the second frequency.

8. The self-standing mountable antenna of claim 1, wherein a leg of the plurality of legs includes a coupling plate configured to be coupled to a surface.

9. The self-standing mountable antenna of claim 1, wherein a leg of the plurality of legs includes a leg pin configured to be received by an aperture in a surface.

10. The self-standing mountable antenna of claim 1, wherein the mountable antenna element is vertically polarized.

11. A printed circuit board mountable reflector configured to reflect a radio frequency (RF) signal, comprising:
a stem configured to extend away from the PCB;
an element coupled to the stem and extending perpendicular to the stem; and
at least one coupling plate coupled to a base of the stem and configured to be coupled to the PCB.

12. The printed circuit board mountable reflector of claim 11, further including at least one pin coupled to the base of the stem and configured to be received by an aperture in the PCB.

13. The printed circuit board mountable reflector of claim 11, the element extending parallel to the PCB.

14. The printed circuit board mountable reflector of claim 11, wherein the stem, the element, and the coupling plate are constructed from a single object.

15. The printed circuit board mountable reflector of claim 11, wherein the element includes a first arm extending in a first direction and a second arm extending in a second direction, the first direction and the second direction being at least ninety degrees apart.

16. The printed circuit board mountable reflector of claim 11, wherein the at least one coupling plate is configured to be coupled to an RF switching element, the RF switching element configured to engage or dis-engage the reflector.

17. A wireless device for transmitting a radiation signal, comprising:
a circuit board configured to receive a mountable antenna element for radiating at a first frequency;
a first mountable antenna coupled to the circuit board and including an RF feed, a top surface, a plurality of legs, and an impedance matching element, the plurality of legs configured to couple the first mountable antenna element to the PCB, the impedance matching element configured to form a capacitance with respect to a ground layer in the PCB; and
a radio modulator/demodulator configured to provide an RF signal to the first mountable antenna at the first frequency.

18. The wireless device of claim 17, wherein the RF feed, a top surface, a plurality of legs, and an impedance matching element are constructed from a single object.

19. The wireless device of claim 17, further comprising a reflector coupled to the circuit board and configured to reflect a radiation pattern of the first mountable antenna.

18. The wireless device of claim 19, wherein the reflector includes a coupling plate for coupling to a mounting pad of the PCB.

19. The wireless device of claim 17, further comprising a second mountable antenna for radiating at a second frequency.

20. The wireless device of claim 12, the first mountable antenna including a stub able to generate an open circuit with respect to the second frequency at a leg of the plurality of legs of the first mountable antenna.

21. The wireless device of claim 20, wherein the first mountable antenna includes a first stub with an outer end and a second stub with an outer end, the open circuit formed at the leg adjacent to the outer ends of the first stub and the second stub.

22. The wireless device of claim 20, wherein the second mountable antenna radiates at a higher frequency than the first mountable antenna.

23. The wireless device of claim 17, wherein the circuit board includes an aperture, the hole configured to receive the reflector.
